(19) United States
(12) Patent Application Publication
(10) Pub. No.: US 2022/0408764 A1
(43) Pub. Date: Dec. 29, 2022

(54) PROCESS FOR PRODUCING INSTANT NOODLES AND AN INSTANT NOODLE PRODUCT FROM DRAGON FRUIT PULP USING ULTRA-SONICATION TECHNOLOGY

(71) Applicant: Quang Huy Le, Ho Chi Minh city (VN)

(72) Inventor: Quang Huy Le, Ho Chi Minh city (VN)

(21) Appl. No.: 17/742,807

(22) Filed: May 12, 2022

(30) Foreign Application Priority Data
Jun. 28, 2021 (VN) 1-2021-03927

(51) Int. Cl. A23L 7/113; A23L 29/212; A23L 29/00; A23L 29/238; A23L 29/269; A23L 5/30

(52) U.S. Cl. CPC A23L 7/113; A23L 29/212; A23L 29/015; A23L 29/238; A23L 29/27; A23L 29/035; A23L 5/32; A23V 2002/00

(57) ABSTRACT

The present invention provides a process for producing instant noodles and an instant noodle product from dragon fruits using ultra-sonication technology, wherein the process comprises: a) Pre-processing dragon fruit ingredients; b) Heating the dragon fruit solution to room temperature; c) Activating the dragon fruit solution; d) Removing impurities of the powdery ingredients through a sieve; e) Performing a catalytic reaction between the activated dragon fruit solution and other ingredients of the instant noodles; f) Proofing; g) Pressing the dough; h) Shape cutting into noodles; i) Steaming instant noodles; j) Macerating with seasonings; k) Cooling and frying (instant noodle product from dragon fruits using ultra-sonication technology with frying); 1) Cooling and drying (instant noodle product from dragon fruits using ultra-sonication technology without frying); m) Cooling; n) Drying and cooling; o) Packaging.

### CROSS-REFERENCES TO RELATED APPLICATIONS

This application claims priority from Vietnam Patent Application No. 1-2021-03927, filed Jun. 28, 2021, the content of which is incorporated by reference herein in its entirety.

### FIELD OF INVENTION

The present invention relates to a process for producing instant noodles and an instant noodle product from dragon fruits using ultra-sonication technology.

### BACKGROUND OF INVENTION

Vietnam ranks fifth in the world with respect to the amount of noodle consumption, and on average each citizen consumes 55 instant noodle packs per year. This is the information mentioned at the Scientific Conference on Fast Food in Modern Society to People's Health, held by Vietnam Medical Association on 18 Nov. 2020 in Hanoi. According to VOV.VN Wednesday, 15:01, 18 Nov. 2020: VOV.VN: Currently Vietnam has ranked fifth in the world in the amount of noodle consumption during the year. China (the most populated country in the world) consumes the most noodle packs with 40.25 billion instant noodle packs per year. Indonesia ranks second with 12.54 billion packs, India with over 6 billion packs, Japan with 5.78 billion packs, Vietnam with 5.2 billion instant noodle packs per year. Vietnam consumes 55 noodle packs/person/year, which is even higher than China (31 noodle packs/person/year), Indonesia with 46 packs, and Japan with 45.8 packs.

On the market there are a lot of different instant noodle products with a variety of ingredients such as emulsifiers, stabilizers, antioxidants, seasonings, flavors, wheat flour, cassava powder, corn powder, and extracts from vegetables, fish, shrimps, and seaweeds, but no instant noodle product contains ingredients from fruits.

As for the types of vegetables or seaweeds, they are easy to be ground and squeezed for juice, while fish and shrimps are also easy to be hydrolyzed and filtered. Vegetable pulps generally do not have a high viscosity, with low, and substantially no, pectin content. The viscosity of the hydrolyzed fluid of fish and shrimps is also very low. Therefore, vegetables or shrimps and fish are usually the ingredients for producing added liquid in production of instant noodles.

Up until the beginning of 2021, the whole Binh Thuan Province had about 33,700 ha of dragon fruits, which was an increase of over 20,000 ha relative to 2010. Products from dragon fruits are mainly sold as whole items and cut for drying. Dragon fruit pulps contain a variety of different bioactive ingredients, such as vitamin C, anthocyanin, betacyanin (betanin (betanidin-5-O-β-glucoside), phyllocactin, hylocerenin), polyphenol (gallic acid (GA), caffeic, ferulic, pcoumaric, sinapic, and ferulic acids), flavonoid (phloretin-2-O-glucoside, and myricetin-3-O-galactopyranoside), vitamin B3, oligosaccharides (fructooligosaccharide, that is 1-kestose, 6-kestose, and neokestose (1 Glc unit and 2 fructose units)), or nystose, bifurcose, and neobifurcose (1 Glc unit and 3 fructose units), or stachyose (3 Glc units and 1 fructose unit), vitamin E (tocopherol), and essential fatty acids. These contribute different medical uses to the dragon fruits, such as reduction of insulin resistance and fatty liver in obese mice. The antioxidant activity of dragon fruits is better than some fruits such as mangos, lychees, longans, and papayas. The antioxidation activity of red flesh dragon fruits is higher than that of white flesh dragon fruits.

However, dragon fruit pulps have a low acid content with pH of 4.4-5.1, high humidity (83-89 g/100 g wet weight), is rich in pectin, and contains many tiny seeds, which leads to great difficulty squeezing for juices. Simultaneously, the fiber in the juice is very high in content and has a great size. Therefore, when the dragon fruit juice is added to the instant noodles, it will create a crumble structure and poor swelling capacity, wherein it does not even swell after the noodles have been fried or dried. The color of red dragon fruits is also not stable under the impacts of steaming temperature, frying temperature, and drying temperature. The binding ability of starch and ingredients to make instant noodles with ingredients of the dragon fruit pulps is very poor, which will be decolored after about 2-3 hours from powder mixing, despite no thermal application.

Therefore, to solve the problem of stability and binding ability between ingredient instant noodles and dragon fruit pulps, swelling capacity, and chewy structure of instant noodles, an ultra-sonic ation technology is applied in production of dragon fruit instant noodles, since the ultra-sonication technology in association with physicochemical technology will allow for a smaller fiber size and solve the above problems. Previous publications on the use of ultra-sound on the dragon fruit pulp were mainly about bioactive extracts. Currently, there has not been any publication all over the world on the application of ultra-sonication technology in production of dragon fruit instant noodles.

### SUMMARY

The object of the present invention is aimed at solving the above problems. Accordingly, the present invention provides a process for producing instant noodles and an instant noodle product from dragon fruits using ultra-sonication technology.

The present invention provides a process for producing instant noodles and an instant noodle product from dragon fruits using ultra-sonication technology with frying, wherein the process comprises the following steps:

a) Pre-processing dragon fruit ingredients;

b) Heating the dragon fruit solution to room temperature;

c) Activating the dragon fruit solution;

d) Removing impurities of the powdery ingredients through a sieve;

e) Performing a catalytic reaction between the activated dragon fruit solution and other ingredients of the instant noodles;

f) Proofing;

g) Pressing the dough;

h) Shape cutting into noodles;

i) Steaming instant noodles;

j) Macerating with seasonings;

k) Cooling and frying;

m) Cooling;

n) Drying and cooling;

o) Packaging.

The present invention also provides a process for producing instant noodles and an instant noodle product from dragon fruits using ultra-sonication technology without frying, wherein the process comprises the following steps:

a) Pre-processing dragon fruit ingredients;

b) Heating the dragon fruit solution to room temperature;

c) Activating the dragon fruit solution;

d) Removing impurities of the powdery ingredients through a sieve;

e) Performing a catalytic reaction between the activated dragon fruit solution and other ingredients of the instant noodles;

f) Proofing;

g) Pressing the dough;

h) Shape cutting into noodles;

i) Steaming instant noodles;

j) Macerating with seasonings;

l) Cooling and drying;

m) Cooling;

n) Drying and cooling;

o) Packaging.

The product produced from the above processes has the following ingredients: wheat starch, in which the ratio of the wheat starch is 100%;

cassava starch, in which the ratio of the cassava starch to the wheat starch is 15%;

dragon fruit, in which the ratio of the dragon fruit to the wheat starch is 5%;

KH₂PO₄, in which the ratio of KH₂PO₄ to the wheat starch is 0.5%;

C₆H₁₀CaO₆, in which the ratio of C₆H₁₀CaO₆ to the wheat starch is 0.5%;

leicethin, in which the ratio of the leicethin to the wheat starch is 0.2%;

edible oil, in which the ratio of the edible oil to the wheat starch is 2%;

gluten, in which the ratio of the gluten to the wheat starch is 15%;

MSG, in which the ratio of MSG to the wheat starch is 2%;

food coloring, in which the ratio of the food coloring to the wheat starch is 2%;

kansui, in which the ratio of the kansui to the wheat starch is 1.5%;

guar gum, in which the ratio of the guar gum to the wheat starch is 2%;

xanthan gum, in which the ratio of the xanthan gum to the wheat starch is 1.2%;

C₆H₉OCH₂COONa, in which the ratio of C₆H₉OCH₂COONa to the wheat starch is 1.2%;

shortening, in which the ratio of the shortening to the wheat starch is 1.2%;

NaCl, in which the ratio of NaCl to the wheat starch is 2%;

C₆₄H₁₂₄O₂₆, in which the ratio of C₆₄H₁₂₄O₂₆ to the wheat starch is 0.5%;

shrimp flavor powder, in which the ratio of food coloring to the wheat starch is 1.5%;

Na₅P₃O₁₀, in which the ratio of Na₅P₃O₁₀ to the wheat starch is 0.2%;

NaH₂CO₃, in which the ratio of NaH₂CO₃ to the wheat starch is 0.5%;

Na₂CO₃, in which the ratio of Na₂CO₃ to the wheat starch is 0.108%;

K₂CO₃, in which the ratio of K₂CO₃ to the wheat starch is 0.1%.

### DETAILED DESCRIPTION OF INVENTION

Hereinafter, the present invention describes specific embodiments in detail, however, these embodiments are only aimed at describing the present invention in detail, but are not aimed at limiting the scope of the claims of the present invention.

Dragon fruits are mainly sold as whole items and cut for drying. Dragon fruit pulps contain a variety of different bioactive ingredients, such as vitamin C, anthocyanin, betacyanin (betanin (betanidin-5-O-β-glucoside), phyllocactin, hylocerenin), polyphenol (gallic acid (GA), caffeic, ferulic, pcoumaric, sinapic, and ferulic acids), flavonoid (phloretin-2-O-glucoside and myricetin-3-O-galactopyranoside), vitamin B3, oligosaccharides (fructooligosaccharide, that is, 1-kestose, 6-kestose and neokestose (1 Glc unit and 2 fructose units)), or nystose, bifurcose and neobifurcose (1 Glc unit and 3 fructose units), or stachyose (3 Glc units and 1 fructose unit), vitamin E (tocopherol) and essential fatty acids These contribute different medical uses to the dragon fruits, such as reduction in insulin resistance and fatty liver in obese mice. The antioxidant activity of dragon fruits is better than some fruits such as mangos, lychees, longans, and papayas. The antioxidation activity of red flesh dragon fruit is higher than that of white flesh dragon fruits. Dragon fruit is wildly cultivated in Vietnam, particularly in Binh Thuan and Long An. However, dragon fruits are not always consumed completely while their quality is still good.

In fact, products from starch are always top priority in human meals, wherein the amount of instant noodle consumption during the year in Vietnam has ranked fifth in the world, with China consuming 40.25 billion instant noodle packs per year, being the top of the world. Indonesia ranks second with 12.54 billion packs, India with over 6 billion packs, Japan 5.78 with billion packs, and Vietnam with 5.2 billion instant noodle packs per year. Vietnam consumes 55 noodle packs/person/year, which is higher than both China (31 noodle packs/person/year), Indonesia with 46 packs, and Japan with 45.8 packs. As such, instant noodles from dragon fruits is one of the important solutions in order to increase the value and use efficiency of dragon fruits.

However, dragon fruits are very rich in fiber and viscous pectin, which makes it very difficult to conform a structure and colorfastness to the instant noodles. Researches have shown that only microencapsulation and nanoencapsulation technologies can conform a structure and colorfastness to the dragon fruit instant noodles. Currently, the most common techniques in Vietnam to produce microcapsule and nanocapsule systems include spray drying and ultra-sonication. However, spray drying is more costly than ultra-sonication. Ultra-sonication is applied in pharmaceutical medicines and dietary supplements to produce microcapsule and nanocapsule emulsion systems.

The present invention provides a process for producing instant noodles and an instant noodle product from dragon fruits using ultra-sonication technology, wherein the process comprises the following steps:

a) Pre-processing dragon fruit ingredients: Prepare dragon fruit ingredients from VietGAP regions right during harvest time, remove impurities by clean water, then rewash by clean cold water. And after obtaining impurity-free dragon fruits, conduct skin removal and grinding at cold temperature to obtain a dragon fruit solution. The grinding aims at decreasing the size of raw fibers and destroying the cellular structure of dragon fruits to as small as possible, and the mixture converts to a homogeneous, slurry, and highly stable suspension. The cold condition contributes to the state stabilization of the suspension. Compared with previous researches, this is an inventive and distinguishing step over previous noodles since there has been no instant noodle product from dragon fruits on the market, and when processing vegetables and aquatic organisms, it does not use techniques as with dragon fruits.

b) Heating the dragon fruit solution to room temperature: Conduct heating the dragon fruit solution to room temperature for the solution to avoid being in the cold state. When the solution is in the cold state, it will decrease gelatinization, decrease activation, as well as increase the contact between starch and different ingredients in the noodles. During the catalyzation, suitable temperature (40-60° C.) will minimize, and even prevent, crumbility, decolorization, and crunchiness of the noodles under the application of steaming temperature, frying temperature, and drying temperature. Compared with previous researches, this is an inventive and distinguishing step over previous noodles since there has been no instant noodle product from dragon fruits on the market and when processing vegetables and aquatic organisms, it does not use techniques as with dragon fruits.

c) Activating the dragon fruit solution: Activate the dragon fruit solution by creating an emulstion that contains microcapsules and nanocapsules under the impacts of ultra-sound. Under the impacts of ultra-sound, micro and nano bubbles are formed and these bubbles will contain hydrophilic agents, hydrophobicagents, cross-linkers, and surfactants to produce a matrix of lasting bubbles. The lasting of the emulsion will contribute to the great chewiness, flexibility, and colorfastness of the noodles. Compared with previous researches, this is an inventive and distinguishing step over previous noodles.

d) Removing impurities of the powdery ingredients through a sieve: Removing impurities is one of the important steps in making instant noodles. During preservation and transportation, starch or other ingredients may absorb moisture and be contaminated, resulting in lumps or impurities, which will influence the texture of the product and food safety.

e) Performing a catalytic reaction between the activated dragon fruit solution and other ingredients of the instant noodles: This is a very important step in production of instant noodles. If the catalytic reaction is not complete and performed with the right procedures, the ingredients will be separated when steamed, or dried and fried, or when exposed to boiling water. The catalytic reaction, under the impacts of rotating arms, will contribute to the increase in elmusion binding and the dispersion of stable nano- and micro-emulsions with starch and salt ingredients, emulsifying ingredients, and stabilizers of the noodles. The step employs mechanical forces and physical techniques to induce chemically catalytical effects. Compared with previous researches, this is an inventive and distinguishing step over previous noodles, since the ingredients in previous noodles are not the same as those of instant noodles from dragon fruits.

f) Proofing; This is a step to increase the existing gluten in wheat flour, which may also be determined as activating and increasing ingredient binding in the dough. After proofing, the dough will be more flexible and strive for water separation. Because of this step, the dough, after being cut into noodles, will be more flexible, more chewy, and more colorfast.

g) Pressing the dough; The next step is to increase the firm binding of ingredients in the dough while gradually converting the dough into thinner sheet. When the flour sheet passes the rollers and is pressed, the chewiness and flexibility of the flour sheet increase.

h) Shape cutting into noodles: In this step, the shape of the noodles is formed based on consumer needs or manufacturer desires.

i) Steaming instant noodles: This step is to gelatinize and absorb water from the noodles for the noodles to be cooked, and consumers may eat the packaged product righ away. Different instant noodle ingredients will require different steaming time and temperatures. The steaming temperatures and time will contribute to the change in the chewiness, flexibility, and cooked and crunchy state of the noodles.

j) Macerating with seasonings: This step is aimed at conforming characteristic flavors in the product based on customer demands and manufacturer desires.

k) Cooling and frying (instant noodle product from dragon fruits using ultra-sonication technology with frying); (with this product, move on to step (m)). Cooled noodles will have moisture removed therefrom, and when fried they will continue to be dehydrated so as to make the noodles more crispy and the preservation longer with lower humidity.

1) Cooling and drying (step (n)) (instant noodle product from dragon fruits using ultra-sonication technology without frying); (with this product, move on to steps (n) and (o)—cooling and packaging). Cooled noodles will have moisture removed therefrom. As for non-fried noodles, they have higher humidity than fried noodles, but less oil than fried noodles.

m) Cooling: Noodles, after being fried and steamed, will be cooled to have the water vapor and moisture partially removed therefrom, and this step is also to test the noodle product and remove those that do not meet the requirements from the product.

n) Drying and cooling: The drying contributes to further decrease in the humidity of the noodles to below 5% in order to increase the preservation time of the noodle product and cool it in avoidance of steaming within the packages, resulting in a decrease in preservation time of the noodles.

o) Packaging: It depends on the market for the product to conduct packaging.

The product produced from the above process has the following ingredients:

| | | | Ratio relative to the net |
|---|---|---|---|
| No. | Ingredient | Unit | weight of wheat flour |
| 1 | Wheat starch | % | 100 |
| 2 | Cassava starch | % | 15 |
| 3 | Dragon fruit | % | 5 |
| 4 | KH₂PO₄ | % | 0.5 |
| 5 | C₆H₁₀CaO₆ | % | 0.5 |
| 6 | Leicethin | % | 0.2 |
| 7 | Edible oil | % | 2 |
| 8 | Gluten | % | 15 |
| 9 | MSG | % | 2 |
| 10 | Food coloring | % | 2 |
| 11 | Kansui | % | 1.5 |
| 12 | Guar gum | % | 2 |
| 13 | Xanthan gum | % | 1.2 |
| 14 | C₆H₉OCH₂COONa | % | 1.2 |
| 15 | Shortening | % | 1.2 |
| 16 | NaCl | % | 2 |
| 17 | C₆₄H₁₂₄O₂₆ | % | 0.5 |
| 18 | Shrimp flavor powder | % | 1.5 |
| 19 | Na₅P₃O₁₀ | % | 0.2 |
| 20 | NaH₂CO₃ | % | 0.5 |
| 21 | Na₂CO₃ | % | 0.108 |
| 22 | K₂CO₃ | % | 0.1 |

### EXAMPLES

Example 1. a) 20 kg of dragon fruits from VietGAP regions right at the time of harvest, impurities removed by clean water were prepared. After impurity-free dragon fruits were obtained, skin removal and grinding at cold temperature were conducted to obtain a dragon fruit solution and divided into 1 kg bags for the study on the weight ratios of dragon fruit to flour of 2.5, 5, 7.5, 10, 12.5, 15, 17.5, 20, 22.5, 25, 27.5, 30, 32.5, 35, 37.5, 40, and 42.5%; b) The cold solution obtained from step (a) was heated to room temperature by a double boiler or left in the room for 2 hours after being removed from the refrigerator, or 5 hours after the solution was removed from the freezer; c) The solution obtained from step (b) was activated by placement in an ultrasonic equipment, and mixtures of edible oil (2%), leicethin (0.2%), C6H10CaO6 (0.5%), Na5P3O10 (0.2%), and food coloring (2%), respectively, were added (percentage based on wheat flour weight). In the activating, the ultrasonic frequency was 37 kHz with a power of 100 W for 30 minutes at 50° C.; d) Ingredients including 100% wheat starch (10 kg), 15% cassava starch, 5% dragon fruit, 0.5% KH2PO4, 15% Gluten, 2% MSG, 1.5% kansui, 2% guar gum, 1.2% xanthan gum, 1.2% C6H9OCH2COONa, 1.2% shortening, 2% NaCl, 0.5% C64H124O26, 1.5% shrimp flavor powder, 0.5% NaH2CO3, 0.108% Na2CO3, and 0.1% K2CO3 were weighed and sieved to remove impurities; (e) The activated dragon fruit solution in step (c) and the ingredients obtained in step (d) were uniformly mixed in order, dry ingredients were uniformly premixed in 10 minutes after addition of each portion of the activated dragon fruit solution for 25 minutes, then dough pressing was conducted twice; (f) The flour mixture obtained in step (e) was refrigerated at 20° C. for 30 minutes; (g) The rested dough obtained in step (f) was pressed 5 times in descending thickness order of the flour sheet; (h) The flour sheet after coming from the fifth pressing roller with a thickness of 0.8 mm was cut into noodles of 40 cm in length; (i) The noodles produced in step (h) were steamed at 100° C. in 5 minutes; (j) Steamed noodles in step (i) were macerated with seasonings; k) Cooling and frying were conducted (instant noodle product from dragon fruits using ultra-sonication technology with frying); (with this product, it was moved on to step (m)); (1) Cooling and drying (step (n)) were conducted (instant noodle product from dragon fruits using ultra-sonication technology without frying); (with this product, it was moved on to steps (n) and (o)—cooling and packaging). As a result, the chewiness, flexibility, swelling capacity, and color of the instant noodles from dragon fruits that applied the ultra-sonication technology was inversely proportional to the weight ratio of dragon fruit to wheat flour. This example already included both the red flesh and white flesh dragon fruits. The chewiness, flexibility, swelling capacity, and colorfastness of dragon fruit instant noodles were moderately obtained with a dragon fruit ratio of 2.5-22.5%.

Example 2. a) 20 kg of dragon fruits from VietGAP regions right during harvest time, impurities removed by clean water, were prepared. And after impurity-free dragon fruits were obtained, skin removal and grinding at cold temperature to obtain a dragon fruit solution and divided into 1 kg bags for study purposes; b) The cold solution obtained from step (a) was heated to room temperature by a double boiler or left in the room for 2 hours after being removed from the refrigerator or 5 hours after the solution was removed from the freezer; c) The solution obtained from step (b) was activated by placement in an ultrasonic equipment, and mixtures of edible oil (1%), leicethin (0.1%), C6H10CaO6 (0.25%), Na5P3O10 (0.1%), and food coloring (1%) (percentage based on wheat flour weight), respectively, were added. In the activating, the ultrasonic frequency was 37 kHz with a power of 100 W for 30 minutes at 50° C.; d) Ingredients including 100% wheat starch (10 kg), 15% cassava starch, 10% dragon fruit, 0.5% KH2PO4, 15% Gluten, 2% MSG, 1.5% kansui, 2% guar gum, 1.2% xanthan gum, 1.2% C6H9OCH2COONa, 1.2% shortening, 2% NaCl, 0.5% C64H124O26, 1.5% shrimp flavor powder, 0.5% NaH2CO3, 0.108% Na2CO3, and 0.1% K2CO3 were weighed and sieved to remove impurities; (e) The activated dragon fruit solution in step (c) and the ingredients obtained in step (d) were uniformly mixed in order, dry ingredients were uniformly premixed in 10 minutes after addition of each portion of the activated dragon fruit solution for 25 minutes, then dough pressing was conducted twice; (f) The flour mixture obtained in step (e) was refrigerated at 20° C. for 30 minutes; (g) The rested dough obtained in step (f) was pressed 5 times in descending thickness order of the flour sheet; (h) The flour sheet after coming from the fifth pressing roller with a thickness of 0.8 mm was cut into noodles of 40 cm in length; (i) The noodles produced in step (h) were steamed at 100 ° C. in 5 minutes; (j) Steamed noodles in step (i) were macerated with seasonings; k) Cooling and frying were conducted (instant noodle product from dragon fruits using ultra-sonication technology with frying); (with this product, it was moved on to step (m)); (1) Cooling and drying (step (n)) were conducted (instant noodle product from dragon fruits using ultra-sonication technology without frying); (with this product, it was moved on to steps (n) and (o)—cooling and packaging). As a result, the chewiness, flexibility, and swelling capacity of the instant noodles from dragon fruits that applied the ultra-sonication technology was not different from the ratio of edible oil, leicethin, C6H10CaO6, Na5P3O10, and food coloring performed in Example 1, but the noodle colorfastness when mixed in hot water and the preservation time were lower than Example 1. This example already included both the red flesh and white flesh dragon fruits.

Example 3. a) 20 kg of dragon fruits from VietGAP regions right during harvest time, impurities removed by clean water, were prepared. And after impurity-free dragon fruits were obtained, skin removal and grinding at cold temperature to obtain a dragon fruit solution and divided into 1 kg bags for study purposes; b) The cold solution obtained from step (a) was heated to room temperature by a double boiler or left in the room for 2 hours after being removed from the refrigerator or 5 hours after the solution was removed from the freezer; c) The solution obtained from step (b) was activated by placement in an ultrasonic equipment, and mixtures of edible oil (2%), leicethin (0.2%), C6H10CaO6 (0.5%), Na5P3O10 (0.2%), and food coloring (2%) (percentage based on wheat flour weight), respectively, were added. In the activating, the ultrasonic frequency was 37 kHz with a power of 70 W for 30 minutes at 50° C.; d) Ingredients including 100% wheat starch (10 kg), 15% cassava starch, 10% dragon fruit, 0.5% KH2PO4, 15% Gluten, 2% MSG, 1.5% kansui, 2% guar gum, 1.2% xanthan gum, 1.2% C6H9OCH2COONa, 1.2% shortening, 2% NaCl, 0.5% C64H124O26, 1.5% shrimp flavor powder, 0.5% NaH2CO3, 0.108% Na2CO3, 0.1% K2CO3, 60% Co Tien flour, and 40% Red Globe flour were weighed and sieved to remove impurities; (e) The activated dragon fruit solution in step (c) and the ingredients obtained in step (d) were uniformly mixed in order, dry ingredients were uniformly premixed in 10 minutes after addition of each portion of the activated dragon fruit solution for 25 minutes, then dough pressing was conducted twice; (f) The flour mixture obtained in step (e) was refrigerated at 20° C. for 30 minutes; (g) The rested dough obtained in step (f) was pressed 5 times in descending thickness order of the flour sheet; (h) The flour sheet after coming from the fifth pressing roller with a thickness of 0.8 mm was cut into noodles of 40 cm in length; (i) The noodles produced in step (h) were steamed at 100° C. in 5 minutes; (j) Steamed noodles in step (i) were macerated with seasonings; k) Cooling and frying were conducted (instant noodle product from dragon fruits using ultra-sonication technology with frying); (with this product, it was moved on to step (m)); (1) Cooling and drying (step (n)) were conducted (instant noodle product from dragon fruits using ultra-sonication technology without frying); (with this product, it was moved on to steps (n) and (o)—cooling and packaging). As a result, the chewiness and flexibility of the instant noodles from dragon fruits that applied the ultra-sonication technology were lower than Example 1 and Example 2 under sensory test. This example already included both the red flesh and white flesh dragon fruits.

Example 4. Steps (a) to (b) were similar to Example 3; c) The solution obtained from step (b) was activated by placement in the ultrasonic equipment, and mixtures of edible oil (2%), leicethin (0.2%), C6H10CaO6 (0.5%), Na5P3O10 (0.2%), and food coloring (2%) (percentage based on wheat flour weight), respectively, were added. In the activating, the ultrasonic frequency was 37 kHz with a power of 100 W for 15 minutes at 50° C.; Steps (d) to (o) were similar to Example 3. As a result, the chewiness, flexibility, and colorfastness of the instant noodles from dragon fruits that applied the ultra-sonication technology were lower than Example 3 under sensory test. This example already included both the red flesh and white flesh dragon fruits.

Example 5. Steps (a) to (c) were similar to Example 4; d) Ingredients including 100% wheat starch (10 kg), 10% cassava starch, 10% dragon fruit, 0.5% KH2PO4, 15% Gluten, 2% MSG, 1.5% kansui, 2% guar gum, 1.2% xanthan gum, 1.2% C6H9OCH2COONa, 1.2% shortening, 2% NaCl, 0.5% C64H124O26, 1.5% shrimp flavor powder, 0.5% NaH2CO3, 0.108% Na2CO3, 0.1% K2CO3, 60% Co Tien flour, and 40% Red Globe flour were weighed and sieved to remove impurities; Steps (e) to (o) were similar to Example 4. As a result, the chewiness, flexibility, and colorfastness of the instant noodles from dragon fruits that applied the ultra-sonication technology were more similar to Example 4 under sensory test. This example already included both the red flesh and white flesh dragon fruits.

Example 6: Steps (a) to (c) were similar to Example 4; d) Ingredients including 100% wheat starch (10 kg), 20% cassava starch, 10% dragon fruit, 0.5% KH2PO4, 15% Gluten, 2% MSG, 1.5% kansui, 2% guar gum, 1.2% xanthan gum, 1.2% C6H9OCH2COONa, 1.2% shortening, 2% NaCl, 0.5% C64H124O26, 1.5% shrimp flavor powder, 0.5% NaH2CO3, 0.108% Na2CO3, and 0.1% K2CO3 were weighed and sieved to remove impurities; Steps (e) to (o) were similar to Example 4. As a result, the chewiness, flexibility, and colorfastness of the instant noodles from dragon fruits that applied the ultra-sonication technology were similar to Example 4 under sensory test, but product was a little crunchy when eaten. This example already included both the red flesh and white flesh dragon fruits.

Example 7: Steps (a) to (c) were similar to Example 4; d) Ingredients including 100% wheat starch (10 kg), 15% cassava starch, 10% dragon fruit, 0.5% KH2PO4, Gluten 20%, 2% MSG, 1.5% kansui, 2% guar gum, 1.2% xanthan gum, 1.2% C6H9OCH2COONa, 1.2% shortening, 2% NaCl, 0.5% C64H124O26, 1.5% shrimp flavor powder, 0.5% NaH2CO3, 0.108% Na2CO3, and 0.1% K2CO3 were weighed and sieved to remove impurities; Steps (e) to (o) were similar to Example 4. As a result, the colorfastness of the instant noodles from dragon fruits that applied the ultra-sonication technology was more similar to Example 1 under sensory test. The chewiness and flexibility were not equal to Example 3 and the swelling capacity in boiling water was also poorer than Example 4, since the noodles were more rigid. This example already included both the red flesh and white flesh dragon fruits.

Example 8: Steps (a) to (c) were similar to Example 4; d) Ingredients including 100% wheat starch (10 kg), 15% cassava starch, 10% dragon fruit, 0.5% KH2PO4, 15% Gluten, 2% MSG, kansui 1.0%, 2% guar gum, 1.2% xanthan gum, 1.2% C6H9OCH2COONa, 1.2% shortening, 2% NaCl, 0.5% C64H124O26, 1.5% shrimp flavor powder, 0.5% NaH2CO3, 0.108% Na2CO3, and 0.1% K2CO3 were weighed and sieved to remove impurities; Steps (e) to (o) were similar to Example 4. As a result, the chewiness, flexibility, and colorfastness of the instant noodles from dragon fruits that applied the ultra-sonication technology were similar to Example 4 under sensory test, but the instant noodle product had a longer swelling time than Example 4. This example already included both the red flesh and white flesh dragon fruits.

Example 9: Steps (a) to (c) were similar to Example 4; d) Ingredients including 100% wheat starch (10 kg), 15% cassava starch, 10% dragon fruit, 0.5% KH2PO4, 15% Gluten, 2% MSG, 2.0% kansui, 2% guar gum, 1.2% xanthan gum, 1.2% C6H9OCH2COONa, 1.2% shortening, 2% NaCl, 0.5% C64H124O26, 1.5% shrimp flavor powder, 0.5% NaH2CO3, 0.108% Na2CO3, and 0.1% K2CO3 were weighed, and sieved to remove impurities; Steps (e) to (o) were similar to Example 4. As a result, the colorfastness of the instant noodles from dragon fruits that applied the ultra-sonication technology was similar to Example 4 under sensory test. However, the chewiness and flexibility were not equal to Example 4 because they crumbled fast in boiling water. This example already included both the red flesh and white flesh dragon fruits.

Example 10: Steps (a) to (c) were similar to Example 4; d) Ingredients including 100% wheat starch (10 kg), 15% cassava starch, 10% dragon fruit, 0.5% KH2PO4, 15% Gluten, 2% MSG, 1.5% kansui were weighed, guar gum was studied at ratios of 1.0, 1.5, 2.0, and 2.5%, and xanthan gum was studied at ratios of 0.8, 1.0, 1.2, and 1.4%. Designs were tested on the ratio of xanthan gum and guar gum according to the conventional matrix. 1.2% C6H9OCH2COONa, 1.2% shortening, 2% NaCl, 0.5% C64H124O26, 1.5% shrimp flavor powder, 0.5% NaH2CO3, 0.108% Na2CO3, and 0.1% K2CO3 were weighed and sieved to remove impurities; Steps (e) to (o) were similar to Example 4. As a result, the colorfastness of the instant noodles from dragon fruits that applied the ultra-sonication technology was similar to Example 4 under sensory test. However, the ratio of xanthan gum and guar gum decreased, and the chewiness and flexibility were not equal to Example 4. The ratio of xanthan gum and guar gum was high, and the chewiness and flexibility were not equal to Example 4 since they became rigid. This example already included both the red flesh and white flesh dragon fruits.

Example 11: Steps (a) to (c) were similar to Example 4; d) Ingredients including 100% wheat starch (10 kg), 15% cassava starch, 10% dragon fruit, 0.5% KH2PO4, 15% Gluten, 2% MSG, 1.5% kansui, 2% guar gum, 1.2% xanthan gum, 1.2% C6H9OCH2COONa, 1.2% shortening, 2% NaCl, 0.5% C64H124O26, and 1.5% shrimp flavor powder were weighed. NaH2CO3 was studied at ratios of 0.25, 0.75, and 1.0%, and Na2CO3 was studied at ratios of 0.05, 0.108, and 0.15%, and 0.1% K2CO3 was studied at ratios of 0.05, 0.1 and 0.15%. Designs were tested on the ratios of Na2CO3, K2CO3, and NaH2CO3 according to the conventional matrix. They were sieved to remove impurities; Steps (e) to (o) were similar to Example 4. As a result, the colorfastness of the instant noodles from dragon fruits that applied the ultra-sonication technology was similar to Example 4 under sensory test. However, the ratios of Na2CO3, K2CO3, and NaH2CO3 decreased, and the chewiness and flexibility were not equal to Example 4 since they were rigid and took a long time to swell in boiling water. The ratios of Na2CO3, K2CO3, and NaH2CO3 were high, and the chewiness and flexibility were not equal to Example 4 since they were popped and swelled rapidly in boiling water. This example already included both the red flesh and white flesh dragon fruits.

Example 12: Steps (a) to (c) were similar to Example 4; d) Ingredients 15% cassava starch, 10% dragon fruit, 0.5% KH2PO4, 15% Gluten, 2% MSG, 2.0% kansui, 2% guar gum, 1.2% xanthan gum, 1.2% C6H9OCH2COONa, 1.2% shortening, 2% NaCl, 0.5% C64H124O26, 1.5% shrimp flavor powder, 0.5% NaH2CO3, 0.108% Na2CO3, 0.1% K2CO3, and Co Tien flour studied at ratios of 40, 50, 60 and 70%, and Red Globe flour studied at ratios of 30, 40, and 50% were weighed and sieved to remove impurities; Steps (e) to (o) were similar to Example 4. As a result, different ratios of Co Tien flour and Red Globe Flour did not influence the chewiness, flexibility, swelling capacity, and color of the instant noodles. This example already included both the red flesh and white flesh dragon fruits.

Example 13. Steps (a) to (b) were similar to Example 4; c) The solution obtained from step (b) was activated by placement in an ultrasonic equipment, and mixtures of edible oil (2%), leicethin (0.2%), C6H10CaO6 (0.5%), Na5P3O10 (0.2%), and food coloring (2%) (percentage based on wheat flour weight), respectively, were added. In the activating, the ultrasonic frequency was 37 kHz with a power of 100 W for 45 minutes at 50° C.; Steps (d) to (o) were similar to Example 4. As a result, the chewiness, flexibility, and colorfastness of the instant noodles from dragon fruits that applied the ultra-sonication technology were similar to Example 4 under sensory test. This example already included both the red flesh and white flesh dragon fruits.

Example 14. Steps (a) to (b) were similar to Example 4; c) The solution obtained from step (b) was activated by placement in an ultrasonic equipment, and mixtures of edible oil (2%), leicethin (0.2%), C6H10CaO6 (0.5%), Na5P3O10 0.2%, and food coloring (2%) (percentage based on wheat flour weight), respectively, were added. In the activating, the ultrasonic frequency was 37 kHz with a power of 100 W for 45 minutes at 60° C.; Steps (d) to (o) were similar to Example 4. As a result, the chewiness and colorfastness of the instant noodles from dragon fruits that applied the ultra-sonication technology were similar to Example 4 under sensory test but the flexibility was higher than Example 4. This example already included both the red flesh and white flesh dragon fruits.

Example 15. Steps (a) to (e) were similar to Example 4; (f) The flour mixture obtained in step (e) was refrigerated at 20° C. for 15 minutes; Steps (g) to (o) were similar to Example 4. As a result, the chewiness and flexibility of the instant noodles from dragon fruits that applied the ultra-sonication technology were lower than Example 4 under sensory test. This example already included both the red flesh and white flesh dragon fruits.

Example 16. Steps (a) to (e) were similar to Example 4; (f) The flour mixture obtained in step (e) was refrigerated at 20° C. for 45 minutes; Steps (g) to (o) were similar to Example 4. As a result, the chewiness and flexibility of the instant noodles from dragon fruits that applied the ultra-sonication technology were better than Example 4 under sensory test. The colorfastness of the product was also better than Example 4. This example already included both the red flesh and white flesh dragon fruits.

Example 17: Steps (a) to (h); (i) The noodles produced in step (h) were steamed. The steaming temperature to cook the noodles were 95, 100, 105, 110, 110, and 120° C. in 5, 10, 15, and 20 minutes, respectively, according to the conventional matrix; Steps (j) to (o) were similar to Example 4. As a result, the chewiness, flexibility, and colorfastness of the instant noodles from dragon fruits that applied the ultra-sonication technology were more similar to Example 4 under sensory test. This example already included both the red flesh and white flesh dragon fruits.

### Advantageous Effects of the Present Invention

A process for producing instant noodles and an instant noodle product from dragon fruits using ultra-sonication technology according to the present invention have achieved colorfastness, binding ability between the dragon fruit pulp and the ingredient instant noodles through the swelling capacity, flexibility, and chewiness of the noodles, contributing to environment protection. The instant noodle product from dragon fruits using ultra-sonication technology may help increase body resistance, cool the body, and provide antioxidation effects, and are derived from nature, which has not been found in the instant noodle products on the market, so it has an advantage over those on the market. Because of the more demanding requiremnts of consumers, health support products and those derived from nature are always top priorities of smart consumers. The instant noodle product from dragon fruits using ultra-sonication technology is a very new product in fastfood processing industry. When the product is introduced into life, it will contribute to the increase in the consumer's perspective on dragon fruit products and the choices of customers when visiting Binh Thuan or consuming instant noodles.

I claim:

1. A process for producing instant noodles from dragon fruits using ultra-sonication technology with frying, wherein the process comprises the following steps:
a) Pre-processing dragon fruit ingredients;
b) Heating the dragon fruit solution to room temperature;
c) Activating the dragon fruit solution;
d) Removing impurities of the powdery ingredients through a sieve;
e) Performing a catalytic reaction between the activated dragon fruit solution and other ingredients of the instant noodles;
f) Proofing;
g) Pressing the dough;
h) Shape cutting into noodles;
i) Steaming instant noodles;
j) Macerating with seasonings;
k) Cooling and frying;
m) Cooling;
n) Drying and cooling;
o) Packaging.

2. A process for producing instant noodles from dragon fruits using ultra-sonication technology without frying, wherein the process comprises the following steps:
a) Pre-processing dragon fruit ingredients;
b) Heating the dragon fruit solution to room temperature;
c) Activating the dragon fruit solution;
d) Removing impurities of the powdery ingredients through a sieve;
e) Performing a catalytic reaction between the activated dragon fruit solution and other ingredients of the instant noodles;
f) Proofing;
g) Pressing the dough;
h) Shape cutting into noodles;
i) Steaming instant noodles;
j) Macerating with seasonings;
l) Cooling and drying;
m) Cooling;
n) Drying and cooling;
o) Packaging.

3. An instant noodle product from dragon fruits using ultra-sonication technology, wherein the following basic ingredients are included:
wheat starch, in which the ratio of the wheat starch is 100%;
cassava starch, in which the ratio of the cassava starch to the wheat starch is 15%;
dragon fruit, in which the ratio of the dragon fruit to the wheat starch is 5%;
KH₂PO₄, in which the ratio of KH₂PO₄ to the wheat starch is 0.5%;
C₆H₁₀CaO₆, in which the ratio of C₆H₁₀CaO₆to the wheat starch is 0.5%;
leicethin, in which the ratio of the leicethin to the wheat starch is 0.2%;
edible oil, in which the ratio of the edible oil to the wheat starch is 2%;
gluten, in which the ratio of the gluten to the wheat starch is 15%;
MSG, in which the ratio of MSG to the wheat starch is 2%
food coloring, in which the ratio of the food coloring to the wheat starch is 2%
kansui, in which the ratio of the kansui to the wheat starch is 1.5%;
guar gum, in which the ratio of the guar gum to the wheat starch is 2%;
xanthan gum, in which the ratio of the xanthan gum to the wheat starch is 1.2%;
C₆H₉OCH₂COONa, in which the ratio of C₆H₉OCH₂COONa to the wheat starch is 1.2%;
shortening, in which the ratio of the shortening to the wheat starch is 1.2%;
NaCl, in which the ratio of NaCl to the wheat starch is 2%;
C₆₄H₁₂₄O₂₆, in which the ratio of C₆₄H₁₂₄O₂₆ to the wheat starch is 0.5%;
shrimp flavor powder, in which the ratio of food coloring to the wheat starch is 1.5%;
Na₅P₃O₁₀, in which the ratio of Na₅P₃O₁₀ to the wheat starch is 0.2%;
NaH₂CO₃, in which the ratio of NaH₂CO₃ to the wheat starch is 0.5%;
Na₂CO₃, in which the ratio of Na₂CO₃ to the wheat starch is 0.108%;
K₂CO₃, in which the ratio of K₂CO₃ to the wheat starch is 0.1%.
